(19) United States
(12) Patent Application Publication
(10) Pub. No.: US 2002/0137475 A1
(43) Pub. Date: Sep. 26, 2002

(54) Anti electromagnetic wave box for a mobile phone

(76) Inventors: Hua-Tai Shou, Chun-Ho City (TW); Hung-Tai Shou, Chun-Ho City (TW)

Correspondence Address: Alan Kamrath, RIDER BENNETT EGAN & ARUNDEL, LLP, 333 South Seventh Street, Suite 2000, Minneapolis, MN, 55402, US

(21) Appl. No.: 09/815,538

(22) Filed: Mar. 21, 2001

(51) Int. Cl. H04B 1/38

(52) U.S. Cl. 455/90; 455/575

(57) ABSTRACT

An anti-electromagnetic wave box for a mobile phone is composed of a first housing and a second housing for receiving a mobile phone therein. The first and second housing are processed with anti-electromagnetic treatment for shielding a user from electromagnetic waves generated by the mobile phone. The first housing has a non-shielded area for covering an aerial of the mobile phone sending and receiving signals. The second housing has a sound hole defined at an upper portion thereof to enable sound waves to transmit out therefrom. A key cover is formed at a lower portion of the second housing for accessibility of a keyboard of the mobile phone. A window is defined between the sound hole and the key cover for visibility of a screen of the mobile phone. Each of the sound hole, the key cover and the window is processed with anti-electromagnetic treatment.

### BACKGROUND OF THE INVENTION

1. Field of the Invention

The present invention is related to a mobile phone box, and more particularly to a mobile phone box which can protect a user from possible harmful electromagnetic waves generated by the mobile phone contained therein.

2. Description of Related Art

Mobile phones in use will generate electromagnetic wave harmful to users' health and thus there is an anti electromagnetic wave sheet adhered on the back of a mobile phone to shield users from electromagnetic waves. However, electromagnetic waves can radiate out from the whole mobile phone, not just the back and so the local protection is not helpful in completely shielding users from the electromagnetic waves.

Therefore, the invention provides an anti-electromagnetic wave box for a mobile phone to mitigate and/or obviate the aforementioned problem.

### SUMMARY OF THE INVENTION

The main objective of the present invention is to provide a mobile phone box which can completely shield a user from electromagnetic waves generated by a mobile phone received therein but does not weaken the mobile phone's ability in sending and receiving signals.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a mobile phone box in accordance with the present invention;

FIG. 2 is a sectional view of a filter provided in a sound hole of the box in accordance with the present invention;

FIG. 3 is a front view of the filter in FIG. 2;

FIG. 4 is a perspective view of the mobile phone box in accordance with the invention;

FIG. 5 is a partial sectional view showing that an adapter is plugged in a mobile phone via an opening of the mobile phone box;

FIG. 6 is a schematic view showing a mobile phone received in the mobile phone box in accordance with the invention;

FIG. 7 is a schematic view showing another mobile phone of a different size received in the mobile phone in accordance with the invention; and

FIG. 8 is an exploded perspective view of a second embodiment in accordance with the invention.

### DETAILED DESCRIPTION OF THE PREFERRED EMBODIMENT

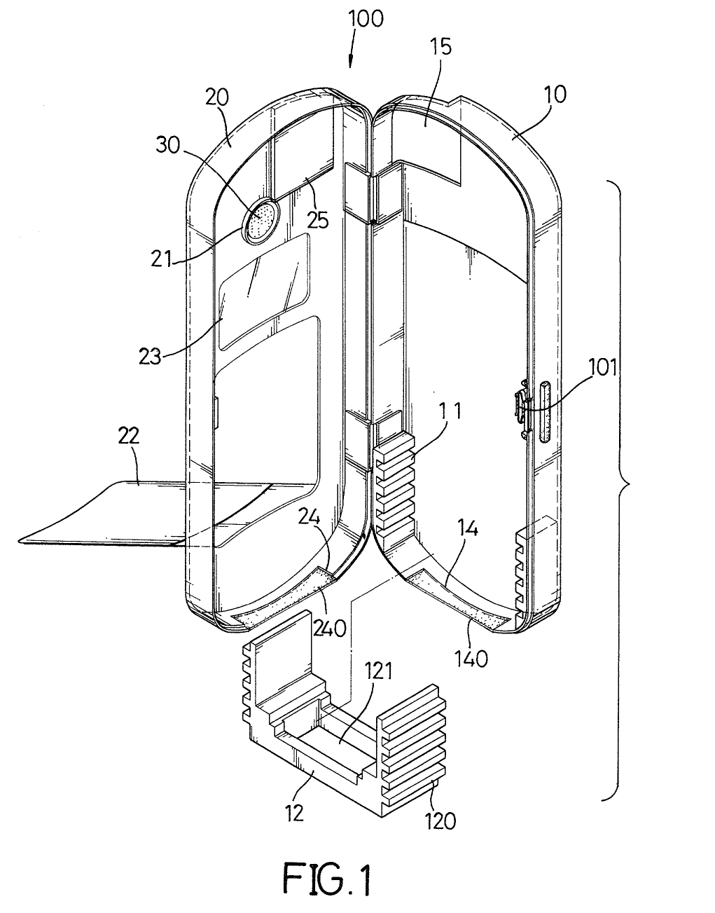

Referring to FIG. 1, a mobile phone box (100) in accordance with the present invention is composed of a first housing (10) and a second housing (20) pivotally mounted with the first housing (10) at a first side of the first housing (10). A mobile phone can be received within a chamber defined between the first housing (10) and the second housing (20) when they are brought together. The first housing (10) has a fastener (101) formed at a second side thereof for securing the first and second housings (10, 20) together to close the box (100). The first housing (10) and the second housing (20) are processed with EMI (Electro Magnetic Interference) treatment, such as plating metal on their surface.

The second housing (20) has a sound hole (21) defined at an upper portion thereof, a key cover (22) provided at a lower portion thereof, and a window (23) defined between the sound hole (21) and the key cover (22).

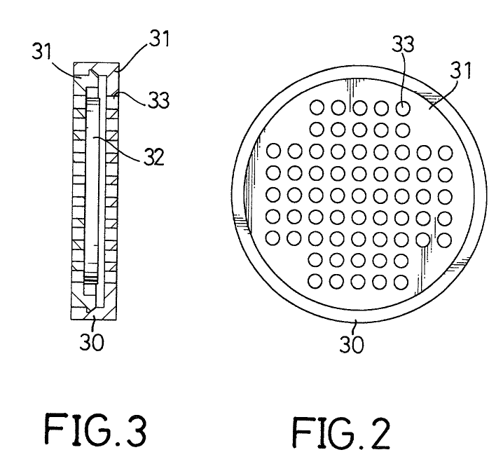

Referring to FIGS. 2 and 3, a filter (30) is provided in the sound hole (21) for filtering electromagnetic waves emitted by a mobile phone (not shown) when received in the box (100). The filter (30) is composed of two casings (31) and a filtering sheet (32) received between the casings (31). The filtering sheet (32) has a coil (not shown or numbered) formed therein to prevent electromagnetic waves from passing from the chamber to an exterior of the box (100). The casings (31) each have a plurality of apertures (33) defined therethrough and sound waves can transmit out from the chamber to the exterior of the box (100) via these apertures (33).

Referring back to FIG. 1, the key cover (22) is in alignment with a keyboard of the mobile phone, and the window (23) is in alignment with a screen of the mobile phone. The window (23) is made of transparent material for visibility of the screen. Both the key cover (22) and the window (23) are able to shield a phone user from electromagnetic waves due to them being processed with EMI treatment on their surfaces. In this embodiment, the key cover (22) is made of a hard material and is pivotally mounted on the second housing (20) for accessibility of keys by a user. Alternatively, the key cover (22) is made of soft and transparent material, and is integrated with the second housing (20), whereby the user can press the keys via pressing the relevant portion of the key cover (22).

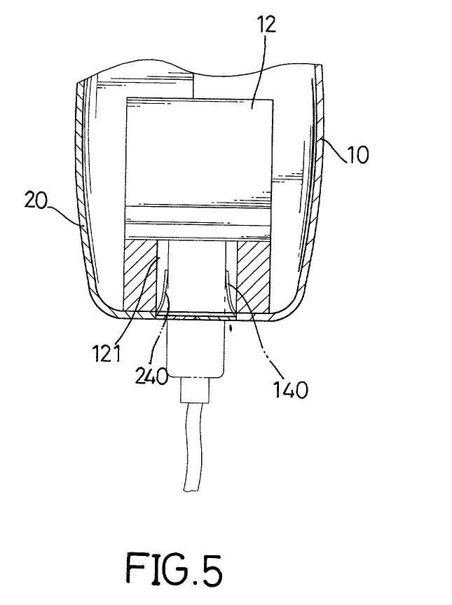

Moreover, the first housing (10) has a first notch (14) defined at a bottom end thereof, and the second housing (20) has a second notch (24) defined at a bottom end thereof. The notches (14, 24) are matched to define an opening at the bottom end of the box for accessibility of an adapter such as a charger or an earphone. A first shield sheet (140) and a second shield sheet (240) are made of flexible material and are respectively provided in the first notch (14) and the second notch (24) to close the opening. By the shield sheets (140, 240), electromagnetic waves are prevented from passing from the chamber to the exterior of the box (100). FIG. 5 shows that the shield sheets (140, 240) are pushed inwards to facilitate an adapter plugging into the mobile phone via the opening.

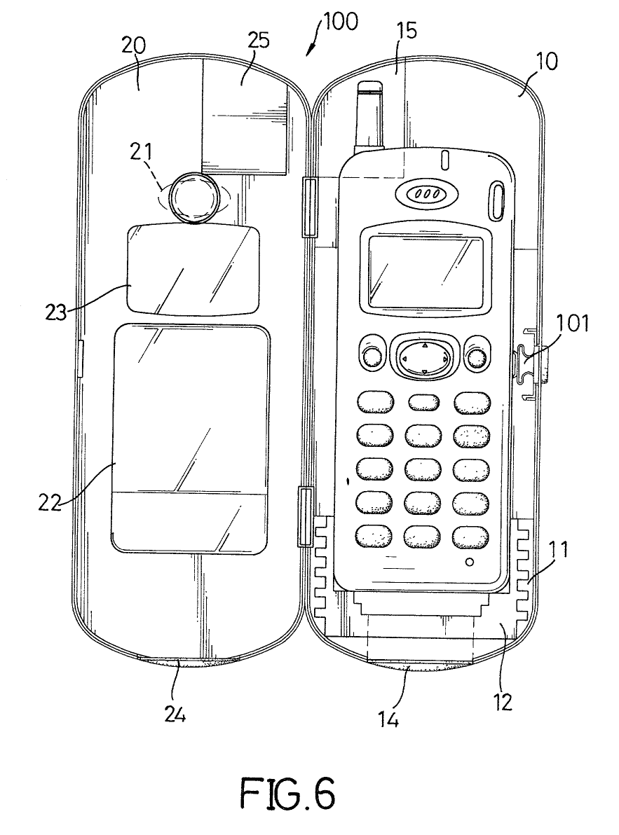

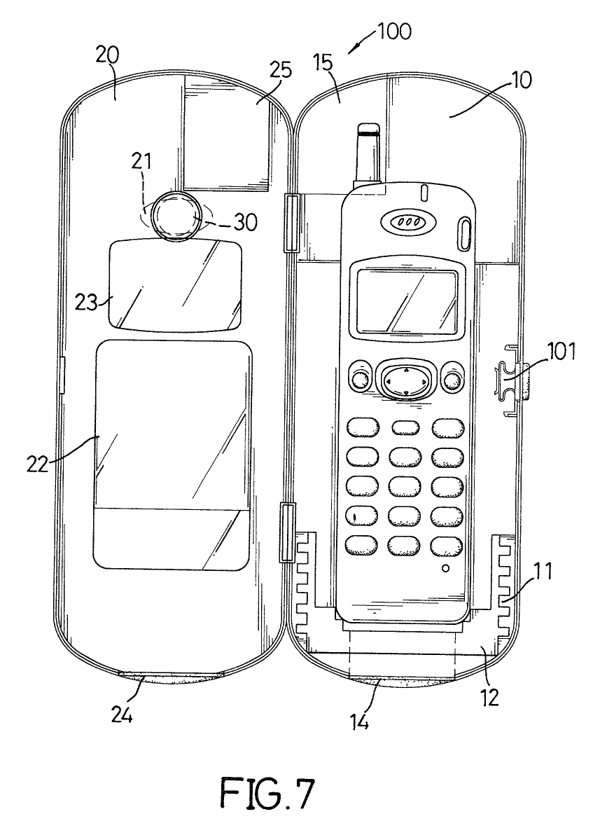

Still referring to FIG. 1, the first housing (10) further has a pair of first racks (11) respectively formed at two opposite bottom inner walls thereof. A U-like adjustable bracket (12) formed with two opposite upright portions and a lateral portion, is provided between the first racks (11) and has a pair of second racks (120) respectively formed at outer surfaces of the upright portions thereof and engaged with the first racks (11). A hole (121) is defined through the lateral portion of the adjustable bracket (12) and in alignment with the first notch (140) and the second notch (240). The bracket (12) is able to be located at various positions to adapt various mobile phones with different lengths received in the first housing (10). Furthermore, steps (not numbered) are respectively formed at corners between the upright portions and the lateral portion to adapt various mobile phones with different widths. FIGS. 6 and 7 show two mobile phones with different sizes respectively received within the first housing (10).

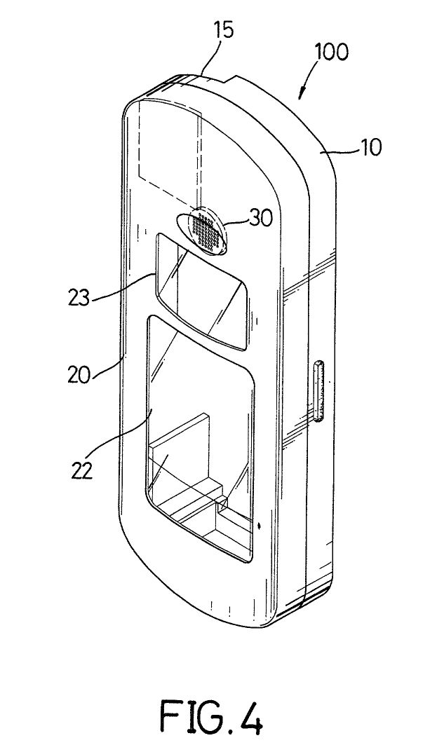

The first housing (10) further has a non-shielded area for an aerial of the mobile phone for receiving and sending signals. In this embodiment, an orifice (15) is defined at an upper portion of the first housing (10). An aerial of the mobile phone extends through the orifice (15) and is able to receive and send signals via the orifice (15). The second housing (20) has a reinforced shield sheet (25) corresponding to the orifice (15) to further prevent electromagnetic waves from passing from the chamber to the exterior of the box (100). An assembled mobile phone box in accordance with the invention is shown in FIG. 4.

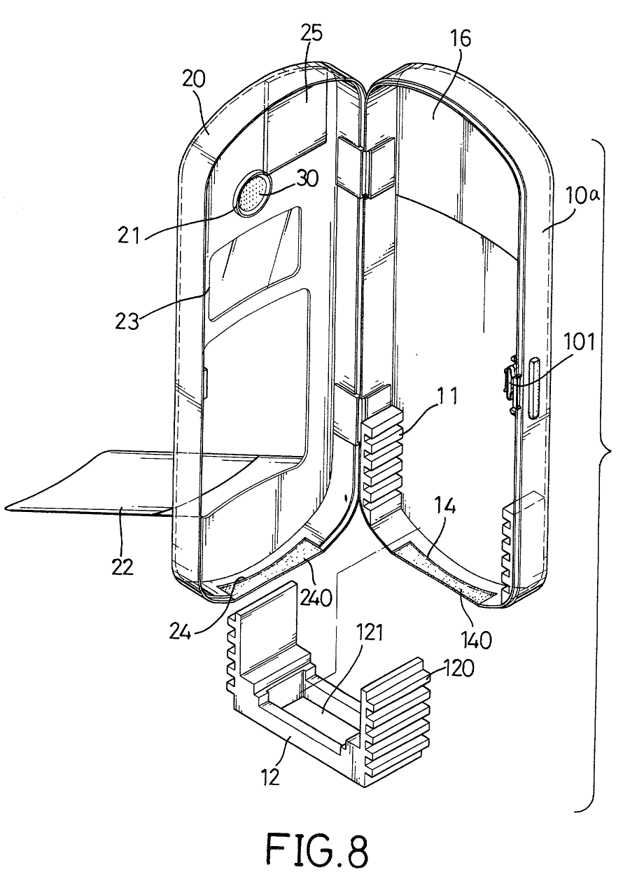

In a second embodiment, as shown in FIG. 8, the first housing (10a) has a non-plated area (16) at the upper portion to correspond to the aerial of the mobile phone. Thus, the aerial is able to receive and send signals via the non-plated area (16).

From the above description, it is noted that the invention has the following advantages:

1. Everywhere in the box that electromagnetic waves can potentially penetrate, including the sound hole, the key cover, and the opening for adapter, is processed with EMI treatment to provide complete protection of a user from electromagnetic waves.

2. The mobile phone box is able to adapt to various mobile phones with different sizes by adjusting the bracket.

3. Via the non-shielded area, the mobile phone can send and receive signals without interference.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An anti-electromagnetic wave box for a mobile phone, the box comprising:
a first housing (10) and a second housing (20) pivotally connected with each other at first sides thereof for receiving a mobile phone therein, wherein
the first housing (10) having a non-shielded area for covering an aerial of the mobile phone sending and receiving signals;
the second housing (20) having a sound hole (21) defined at an upper portion thereof to enable sound waves to transmit out therefrom, a key cover (22) formed at a lower portion thereof for accessibility of a keyboard of the mobile phone, and a window (23) defined between the sound hole (21) and the key cover (22) for visibility of a screen of the mobile phone, wherein each of the sound hole (21), the key cover (22) and the window (23) is processed with anti-electromagnetic treatment.

2. The anti-electromagnetic wave box as claimed in claim 1, wherein the first housing (10) and the second housing (20) respectively have a first notch (14) and a second notch (24) defined at respective bottom sides thereof and matching each other to form an opening for accessibility of an adapter of the mobile phone.

3. The anti-electromagnetic wave box as claimed in claim 2, wherein the first notch (14) has a flexible first shield sheet (140) provided thereon, and the second notch (24) has a flexible second shield sheet (240) provided thereon.

4. The anti-electromagnetic wave box as claimed in claim 1, wherein the first housing (10) has a U-like adjustable bracket (12) formed with two upright portions and a lateral portion provided therein, and having a hole (121) defined through the lateral portion.

5. The anti-electromagnetic wave box as claimed in claim 4, wherein the first housing (10) has two first racks (11) formed at two opposite inner walls thereof, and the adjustable bracket (12) has two second racks (120) formed at the upright portions thereof and engaged with the first racks (11) respectively.

6. The anti-electromagnetic wave box as claimed in claim 4, wherein the adjustable bracket (12) has steps formed at corners of the upright portions and the lateral portion thereof.

7. The anti-electromagnetic wave box as claimed in claim 1, wherein the non-shielded area of the first housing (10) is an orifice (15) for the aerial to extend out therefrom.

8. The anti-electromagnetic wave box as claimed in claim 1, wherein the non-shielded area of the first housing (10) has no anti-electromagnetic material plated thereon.

9. The anti-electromagnetic wave box as claimed in claim 1, wherein the first housing (10) has a fastener (101) formed at a second side opposite to the pivoted first side for securing the first and second the housings (10, 20) together.

10. The anti-electromagnetic wave box as claimed in claim 1, wherein the key cover (22) is made of hard material and pivotally mounted on the second housing (20).

11. The anti-electromagnetic wave box as claimed in claim 1, wherein the key cover (22) is made of soft transparent material and integrated with the second housing (20).

12. The anti-electromagnetic wave box as claimed in claim 1, wherein the sound hole (21) has a filter (30) provided therein, which is composed of two casings (31) and a filtering sheet (32) retained between the casings (31).

13. The anti-electromagnetic wave box as claimed in claim 12, wherein the casings (31) each have a plurality of apertures (33) defined therethrough.
